(19) United States
(12) Patent Application Publication
(10) Pub. No.: US 2016/0350822 A1
(43) Pub. Date: Dec. 1, 2016

(54) Web and Mobile Based Messaging System for Communications Between Buyers and Sellers

(71) Applicant: Yellcast, Inc., San Carlos, CA (US)

(72) Inventor: Venkat Ganesan, San Carlos, CA (US)

(21) Appl. No.: 15/187,474

(22) Filed: Jun. 20, 2016

Related U.S. Application Data
(60) Provisional application No. 62/157,298, filed on May 5, 2015.

(51) Int. Cl. G06Q 30/06; H04L 12/58

(52) U.S. Cl. CPC G06Q 30/0605; H04L 51/046

(57) ABSTRACT

The present disclosure provides for an on-line venue in which buyers can anonymously or otherwise communicate what product or service they want to purchase by posting an interactive request that a number of sellers can then directly respond to. This can promote the buyer's interests in directly matching their needs with qualified vendors. A buyer's needs can be broadcast to relevant sellers or service providers that can be preselected by the buyer. Such embodiments may take the burden from a buyer in finding the right products and services by self-qualifying the request to proactive prospective sellers.

### CROSS-REFERENCED APPLICATION

This application claims priority to U.S. Provisional Application No. 62/157,298, filed May 5, 2015, which is incorporated in its entirety by this reference.

### BACKGROUND

This disclosure relates in general to a buyer-motivated online marketplace in general as well as an online marketplace where buyers and may communicate about needed products and services, amongst other things, from new and existing web and mobile based messaging services.

With current Internet interactions between buyers and sellers, the interaction is typically seller-centric, with advertisements and big data analytics that track the buyer and invade their privacy while those buyers are searching for products and services. Often what is available is limited to just what is posted by sellers. There is a significant gap in the ability for the buyers to be able to communicate exactly their needs and wants to the potential sellers or service providers. When buyers search online, hours can be spent filtering search results, trying to contact different sellers and repeatedly explaining what they need. Buyers end up reaching out to one, maybe two sellers. It is unlikely they are getting the best price, much less the best match.

A large percentage of sellers or service providers are not very savvy with advertising online and remain technically challenged with setting up websites, identifying the best places to advertise and optimizing their ad and website click rate performance. Even the databases that hold their business information regularly do not include their contact information such as email or text message mobile numbers except their voice phone numbers and address. Sellers buy display advertisements or auctioned keywords and pay per click or by page views. Sellers hope that interested buyers will click on their links, visit their website then contact them directly with a request that generates new business. Sellers get clicks by mistake, clicks just for info. They get charged for every click whether they get a request or not. When they do get a real request for services, they pay for all the clicks it took to get there. The vast majority of sellers listed get nothing, while the vast majority of buyers simply do not click on advertisements or paid links. Search partners are not monetizing their own buyers at a comparable rate. Current search income depends on an auction methodology that encourages sellers to overbid the others and pay more for what they do not really need. Meanwhile, buyers are getting a lot of advertisements that they do not really want. Their searches, emails and other personal and private information are tracked, resold and exploited to generate revenues. More importantly, no revenue is generated from organic search results, which represent a majority of the sellers or service providers. This click based revenue model has not changed much since its inception over more than a decade ago.

### BRIEF SUMMARY

In one embodiment, the present disclosure provides for an on-line venue in which buyers can privately communicate precisely what product or service they want to purchase by posting an interactive request with details not limited to a text message, photos, video, audio and files, that a number of sellers can then directly respond to in a public or private conversation with the buyer. This embodiment may enable the buyers who are already using the web or mobile applications to now communicate their interests in directly matching their needs with qualified vendors.

Embodiments of the present invention broadcast a buyer's needs to relevant sellers/service providers from existing and new web based services and mobile applications. Such embodiments may take the burden from a buyer in finding the right products and services by self-qualifying the request to proactive prospective sellers through existing and new web based and mobile messaging systems.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### DESCRIPTION OF THE FIGURES

FIG. 1 through FIG. 20 illustrate aspects of the present invention.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

In one embodiment, the present disclosure provides for a buyer motivated online marketplace implemented by a web-based service. The web-based service might comprise computer systems, databases, and web server interfaces. With such hardware, a provider of the service can accept requests from client systems to serve up webpages, obtain information from users of the service and use the computer systems to generate responses. In this manner, buyers interacting with the web-based service would see and/or hear (via the buyer's client device, such as a computer with a browser, a smart phone, a smart watch, and/or a tablet computer that is connected to the Internet. According to this embodiment of the invention, a buyer may approach a website, for example, at the URL http://yellCast.com using a browser, or access the web-based service using a a downloaded mobile application on a user's smartphone, other mobile device, or a partnered website or mobile application. A “website” might refer to computer systems, databases, and web server interfaces that collectively provide and accept information for buyers and/or sellers.

Buyers using yellCast fast track their search by choosing and reaching multiple sellers with the same request. They select the yellCast checkbox or button in front of each search result for each seller they decide to contact. Buyers can type a text message request, record a video or upload photos and send it to all selected sellers at once. They can specify price and outline any other requirements they may have. They can choose to remain anonymous. What personal data is saved is at the discretion and control of the buyer. There is no mobile application software download and install that is required. Buyers save time, get better pricing and get the best match online or on their mobile devices.

With every selected check box, sellers receive an actual request message via phone, text or email from a motivated buyer. The way to reach the sellers by their voice phone enables the service to reach those sellers and service providers who were not reachable except through their voice phone when the buyer called them one by one. These sellers may not advertise on line and may or may not have a web presence. The system presented enables a highly scalable automated seller and service provider reach platform to connect them with motivated buyers in a more contextual and instant manner.

The sellers can review the requests and the irrelevant requests that they got can be ignored at no cost. Only when sellers accept and pay for the request do they get to connect with the buyer. Sellers get more relevant requests at a fraction of the cost of their current online advertisement buy. Since the buyer is choosing multiple sellers, the value of paying for the first advertisement position declines in proportion to the number of sellers chosen.

The web-based service might include a built-in CRM and analytics engine to manage the requests and convert customers. Sellers might be ranked by actual buyers and sellers, requests received and completed transaction experiences.

This structure enables partnerships. Search partners can receive revenue from four to five or even more sellers for each unique buyer request. Requests can come from both advertisements or organic search results. Each seller pays the search partner in real time for an accepted request. With each checked organic search result the search partner can acquire a new customer who more than likely has not previously bought web advertisements.

The yellCast request based engine brings sellers steps closer to motivated buyers and significantly reduces the cost of advertising inherent in a click-based model. Sellers save on their advertising, buyers save time and get exactly what they want. Since the buyer is requesting exactly what they want, and where and when they want it, the value of tracking the buyer's personal data significantly diminishes. Search partners get a scalable new local and national revenue source and new customers without the added cost of a local sales team.

The buyer may utilize the existing messaging box to type in a request, addressed to yellCast.com. The request message may include hashtags, which are commonly used on the web to specify the type of request as a search phrase that defines the desired product or service. Alternately, the buyer may be presented with a search box where they can type their desired product or service. Alternate ways of getting data using voice recognition software may also be used. Additionally, the request message may include audio, video, photos or other files associated with their search request.

The website may also automatically identify the buyer's location to the closest city or state using IP address mapping through the web browser or from the GPS location coordinates if from a mobile device. The user can manually enter the location or override the default choice and enter a different location where they are seeking the product or service.

In the case of many existing systems, the buyer identity and contact information is already present within their system and does not require to be entered by the user when submitting their request. The method of enabling existing messaging systems offers the users a consistent user experience with what they already are used to messaging their friends and family in the context of a social network or a messaging service.

The request when received by the third party or partnered messaging service or yellCast system will then parse the request which includes the hashtags and location. The parsing may also include data pre-parsed from other existing third party messaging systems through an API. Once the parsing is done, the system can then match the best set of sellers/service providers in the location specified and the search phrase. Any attached audio, video, photos and files may be saved to be forwarded in the form of actual files or just the URL links to reference from the third party or partner messaging systems.

Various embodiments of the present invention may provide a number of benefits to a buyer. For example, these embodiments eliminate the need for registering with another search service to send a search request for a product or service. Users do not have to search for needed products and services from several websites. Users are notified instantly when a match of one or more sellers or service providers are found, through the same messaging service.

As another exemplary benefit, communicating their intention for product or service may be done with the click of a button without having to manually go through each online listing or blindly relying on a third party to match their request with unknown sellers or service providers or even looking up printed yellow page and phone number, calling each of them and repeating the same information. Moreover, using these embodiments of the invention, the power to shop now shifts to the buyer with the ability to reach all the listed suppliers at once from their existing messaging application either through the web or mobile application. As a final example, the buyer may be notified of a response from a potential seller or service provider and continue a conversation thread through the same system. They can continue their conversations and negotiations until a decision is made. Finally, once they have decided can get a firm quotation, any contract documents, product/service specifications and details to review and accept. Further, after the product sale is done or service is completed, the same system may be utilized to bill the buyer with invoices and collect payments.

Various embodiments of the present invention may provide a number of benefits to a seller. For example, sellers receive qualified request directly from motivated buyers. Moreover, sellers do not have to advertise on other click-based or display-based advertising systems, go through optimization processes to advertise on search engines for paid clicks, display impressions or invest in efforts to be picked up by search engines for free listings. Moreover, sellers and service providers can understand their buyer's specific needs better and continue to improve their product or service offerings, without the need for tracking the buyer's actions.

Embodiments of the invention may include any of the following features. A request-based online marketplace matching of buyers and sellers or service providers based upon the requests made by the buyers. Buyers can remain anonymous until they decide to reveal their identity using the intermediary system to relay their requests and further communications through message notifications through mobile applications, emails, text messages, phone calls or web pages. A request-based online marketplace may also provide search and matching algorithms that pre qualifies a sellers and service providers with reviews, ratings and other credible information including photos, videos, accreditations, certifications and other credentials. A request-based online marketplace may source the matched sellers and service providers from other third party websites through APIs. The information sourced from those third party websites may include photos, videos, reviews, accreditations, certifications, open hours, location, distance, business history and features of their product or services and business information. The search matching may also include other search engines. When the search results are obtained without any contact information, the system may include a parser that retrieves the web page data from the search results URL, searches within that text for a contact page URL, fetches the contact page URL and parses that contact page text and html code to get a contact email and phone number if available. A request-based online marketplace may also allow buyers to elect which sellers that can be contacted or send their request to. Moreover, buyers may further rate and/or rank sellers based on their experiences and other buyers can view a seller or service provider's reviews, rating or ranking prior to entering into a transaction. The fact that the system knows both the buyers who sent their request and the sellers or service providers who were contacted enables the system to validate the matched buyers and sellers and ask them about their experience, including if they actually did the business transaction and if they had a positive experience and if they would recommend it to others.

A request-based marketplace, for example, may search for the requested product or service from multiple external sources such as listing services like Yahoo, Yellowpages, Yelp, Google, CityGrid, etc., or find matched sellers or service providers from databases such as Acxiom, Infogroup, Localize, and others. The matched results may include reviews, ratings, distance from the buyer requested location, hours of operation, history of business, accreditations, certifications, photos and videos. In addition, there may be discounted offerings for their product or service made available. The buyer is enabled to send their request to multiple of the sellers or service providers to get responses from anyone who can best service their request.

Other exemplary features of the request-based online marketplace may include the following: Providing the site free to buyers. Requiring sellers to pay a subscription to obtain information about a buyers request or respond to the requests that they are interested in. For example, requesting periodic subscriptions such as monthly or yearly subscriptions. The price for a subscription may vary based on location and category. Other subscriptions may require fees from the seller based on the number of transactions, the amount of a transaction, the number of notifications, or matches per cycle or a fee to respond to the request. The website may include advertisers that pay a fee for advertising within selective sections. These advertisements may include banners, sponsored links, related or featured items (sponsored), most popular products within category (sponsored), etc. A reward may be returned to the buyer, as a percentage of the transaction, based on which, the service yellCast gets a percentage of the transaction.

The buyer motivated market place may be hosted on a web server, for example, an Apache web server using SQL, PHP, Javascript, AJAX technologies. An exemplary web site, implemented by a web-based service running on appropriate computing systems, may include any of the following features either singularly or in combination:
Web page to enter their search phrase along with the location
Automatic default location information from the browser (IP address or Cell Triangulation or GPS-based)
The location-based matching may be hierarchical by which, the buyer may request a nationwide search or statewide search or citywide search or even a specific locality or within a neighborhood.
Alternately, the location may be specified using zip code with a distance radius parameter.
The request message may include the keyword search phrase by means of hashtag delimiters (# sign) or by other escape characters.
The search phrase once the buyer stats typing is augmented with auto suggest feature, that matches the search phrase string from internal database or external web sources through an API request.
An alias of the search phrase may be maintained to cover a wide range of terms ex:

cars aliased with vans, trucks, automobiles, auto etc.
Matching of listings from internal database of sellers and service providers
Matching of listings from external websites through API feeds of sellers and service providers
Aggregating logic for combining results from multiple sources of seller and service provider data including photos, videos, reviews, ratings, business information and discount offers. The data obtained may have to be normalized for consistent comparison example rating scores may be on a different scale from different sites and need to be normalized.
Aggregated data of seller information can be sorted in alphabetical order or by average rating score or by distance or by discount offers with the click of a button.
Ability to select multiple sellers and service providers with a checkbox or a select button.
Ability to send a request to the selected sellers or service providers.
Ability to use the last button selected to send the request to, without having to scroll to the top or bottom of the page.
The option to automatically select the top sellers and send them the request may be presented to the buyer without displaying the listings and they selecting from them.
The request may include photos, videos that can be taken from their computer or Smartphone or tablet device or selected from already saved files.
The capture and upload of photos and videos may be implemented from HTML5 based web pages or from a downloaded mobile application.
The request information may be first obtained from the buyer before they select the sellers or service providers or, alternately, they may first select the sellers or service providers before they enter their request to be sent.
The request may be sent by the buyers from the yellCast web pages or mobile applications may be obtained from other websites or mobile applications through an API.
The request may be posted on a web page along with the photos and videos and the link to the web page may be sent to the sellers and service providers by email, text message, downloaded mobile application message posting or as a voice call to their phone, notifying of a request that is available for them.
The voice calls may be staggered or sequenced so that the buyer does not get inundated with phone call responses from selected sellers at the same time.
The option to cancel the request at any time will stop further phone calls or email/text responses from the system.
When the sellers or service providers are reached through their phone, mobile or land line, the request notification is conveyed to them using text to speech (example: “we have a call for you from yellCast from an interested buyer . . . details: ‘ . . . we need a limo for this weekend.’ To view this request, visit yellCast.com and enter your phone number. Sign-up and get more requests from interested buyers. You can now press zero to contact the buyer”) and they are connected to the buyer through the phone call by dialing the buyer and bridging the call between the buyer and seller through a voice telephony system such as CDYNE or Twillo.
In the case when the seller may have missed the information from the phone call or if it goes to their voice mail unanswered, they are directed to visit the website to enter their phone number and an optional security code to retrieve their request. This enables the service to reach sellers and service providers who are not aware of their request that is matched and pending for them to view.
When the seller or service provider is contacted through their phone they may be connected to the buyer phone directly through the phone system service. Using this intermediary phone system service, the actual phone numbers may not be revealed on the caller ID when the buyer or seller or service provider is reached on their phones.
After a few sample requests, the seller or service providers may be required to sign up and pay to continue to get requests or pay each time to review and respond to the requests.
The sellers when they get the request message may be presented with the option to dial “1” as an example to connect to an operator to help sign up the seller to continue to get requests further after they have signed up and agree to pay to get further requests and respond to them.
The buyer request and seller responses may be posted on a web page that is accessed by both the buyer and sellers. However, the buyer can view all the request and response threads (one to all) including the media such as photos and videos exchanged whereas the sellers may only see the request and responses that pertains to their communications (one to one) and not of the other sellers.
The method of accessing this dashboard web page for the buyer and seller sides may be using a hashed code passed through the URL for the web page and the same URL may be communicated with a short message to the buyer and seller respectively.
Once the seller or service provider's contact information phone number, mobile number, email is obtained, they will be notified of any further requests or responses through a voice message, text/SMS message or email. Alternately, they may also download a mobile application and get notifications through the application.
To maintain anonymity of the buyer and or seller or service provider, the system may not reveal the identity or contact information about either party and use an internally mapped relay email or phone number to reach them. Alternately, a web link with a URL based parameter with a generated code, internally mapped through the database to match the buyer and seller or service provider may be used to view the request and responses.
Once the seller or service provider signs up with the system, they may add edit or maintain their data including their business information, photos, videos, discount offers etc.
The system may enable real time instant messaging from web pages or mobile applications to one on one communicate between the buyers and sellers or service providers. The buyer may do this to ask a quick question to a specific seller or service provider. The instant messaging may be text-based or audio-based or video-based.
yellCast may offer its service through other affiliates or partners. The partners may be identified using a code and tracked to share the earned revenues.
Analytics is incorporated into the system for optimization of performance, obtain intelligence and make improvements. The analytics may include user data, their navigational patterns, terms used, methods and options chosen by them and the type of request/responses generated.
The seller or service provider is enabled with a CRM (Customer Resource

Management) that is built within the system or integrated to an external CRM through an API.
The CRM may include tracking of status, action to be taken, notes of each potential customer, assignment to another staff member to follow up with the potential buyer, send quotes, service contracts and agreements, other files, invoices and receipts.
The CRM may also include payment information, partial payments, aging of payments due and monthly summary for further data export to other financial systems.
Seller Dashboard-Web Front System for customer response management—sellers can view the buyer requests on a dash board with advanced features to sort, search and filter by dates, search terms, source of data, etc. They can initiate responses from this console, keep track of their responses to each buyer request and manage their customer interactions.
Payment method for sellers—sellers pay for requests or responding to the requests that they can fulfill on yellCast using their credit/debit card, check, PayPal or other web-based payment methods. We may also collect payment offline through sales agents. Alternately they may pay using BitCoin Internet currency.
In another possible method, sellers may agree to pay yellCast, a portion of the revenue made through the request.
In another possible method, sellers may just pay a flat fee for any number of requests.
Buyers may pay for the product or service through yellCast using their credit/debit card, check, PayPal or other web-based payment methods. Buyers may also pay using BitCoin Internet currency.
Localization—the web service or mobile application may be localized to various countries and regions with language translations for the requests, listings, and interface. Currency may be converted to the local denomination and displayed in the local format.
yellCast partnership-based versions may be co-branded and themed to match a custom look and feel.
Buyers may make some of their sellers or service providers as their favorite and become a reference for them. When others request a reference, they can communicate with the requestor in a confidential manner and provide the reference.
Sellers or service providers may request their existing clients or customers to become a reference for them. The sellers or service providers may accomplish this by sending out an email message to all their clients, requesting and inviting them to be a reference for them.
Sellers or service providers may maintain a list of the buyers and contact them further on future promotions, product or service offers, new product information or any other marketing information including newsletters about any relevant information that might be of interest. The CRM system enables mass electronic dissemination of this information based upon the buyer preferences.

The website is developed using PHP with AJAX and/or MySQL database(s). The core engine is designed to be highly responsive and scalable. Structured database queries may be setup with variable fields for each form. Listings may be quick searchable and sorted in alphabetical order. Queries may be saved and retrieved for matches each time new data is added in that category. The system interfaces may be modular to interface with internal database, external database with queries or API. (There are other ways to implement the logic including but not limited to JSP, ASP or other databases MS SQL, Oracle, etc.

An example computer system for servicing the buyer-motivated online service might comprise one or more of the following modular components, integrated seamlessly with well-defined interfaces:
Core database (Categories, Location, User information)
Common Classes, Libraries (sessions, image handling, etc.)
User front-end—CS S/Templates
Personal mailbox bins
Search and match
Request module
Notification module
Interface to internal and external data sources and/or API
Mobile data exchange module
Business listing module
Payment module
Analytics module
Security Layers
Advertisement & Promotion engine
Mobile applications and adapted reformatted web interface

While the principles of the disclosure have been described above in connection with specific apparatuses and methods, it is to be clearly understood that this description is made only by way of example and not as limitation on the scope of the disclosure.

### Example Implementation

This section explains a detailed example. The scope of the disclosure should not be limited by the exemplary detail disclosed in this section. In the examples, a specific social media platform is used, but it should be understood that this implementation might use some other social media platform instead.

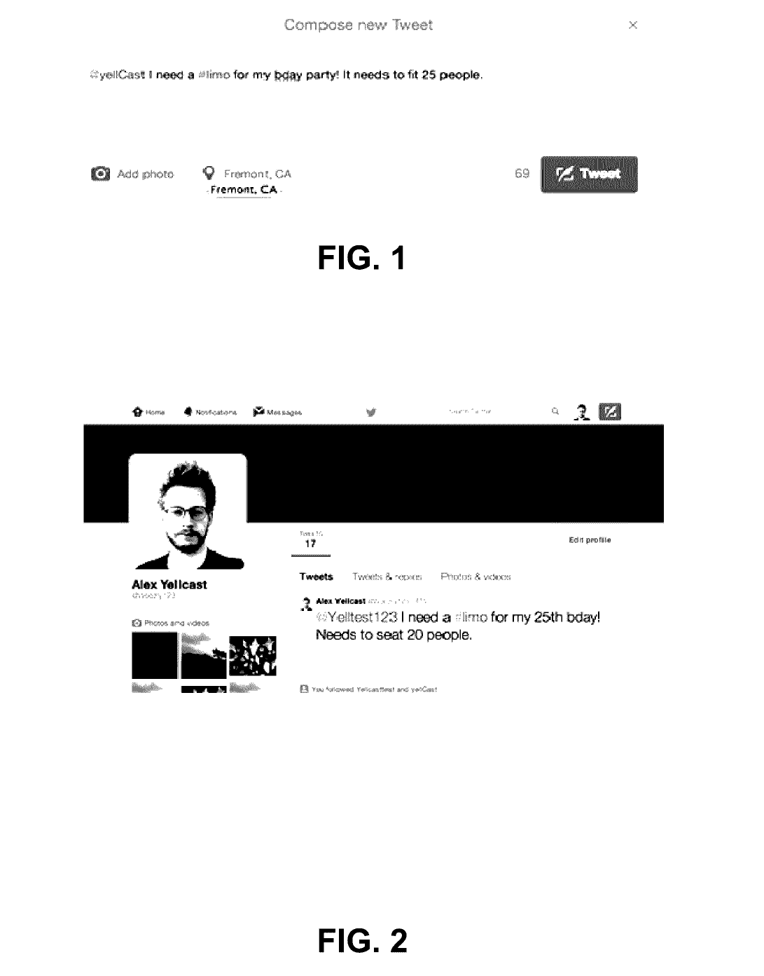

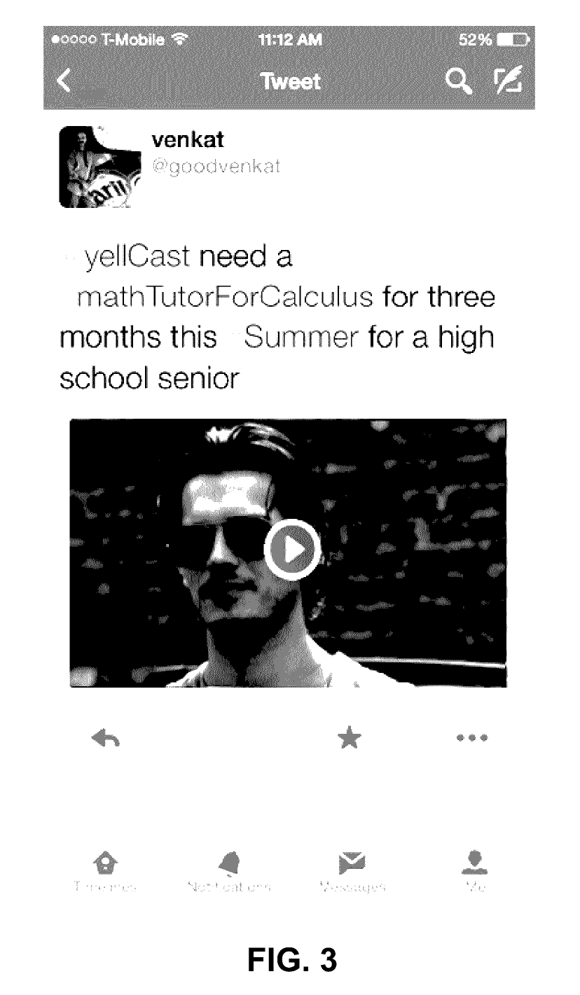

In this example, a motivated buyer signals a request for a product/service. For example, using the Twitter service, a motivated buyer tweets @yellCast from his/her twitter account to message local businesses with a request for goods or services, as illustrated in FIG. 1. The buyer's results for what they want are based on the #hashtags in the message, and location services should be turned on (for where they want it). The buyer can also add photos/videos and a brief message. This might show up as shown in FIG. 2. FIG. 3 illustrates a mobile application screenshot example.

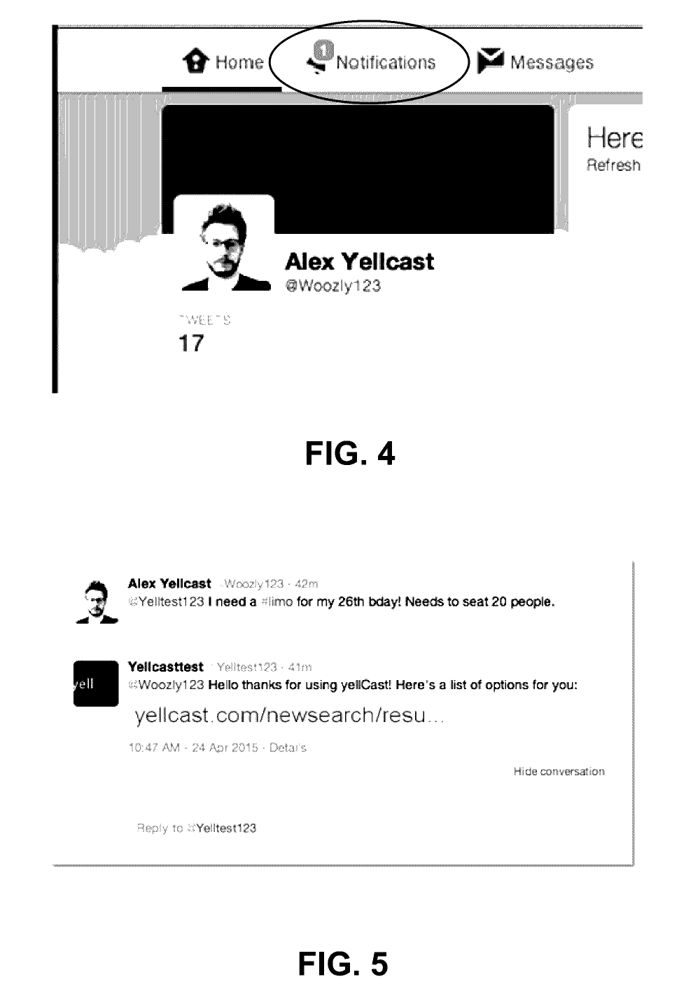

In response, the buyer receives a notification of a reply to their tweet within seconds that includes a link to a list of potential sellers/service providers near the specified geo-location, as illustrated in FIGS. 4-5. Other mechanisms for feedback might be used instead.

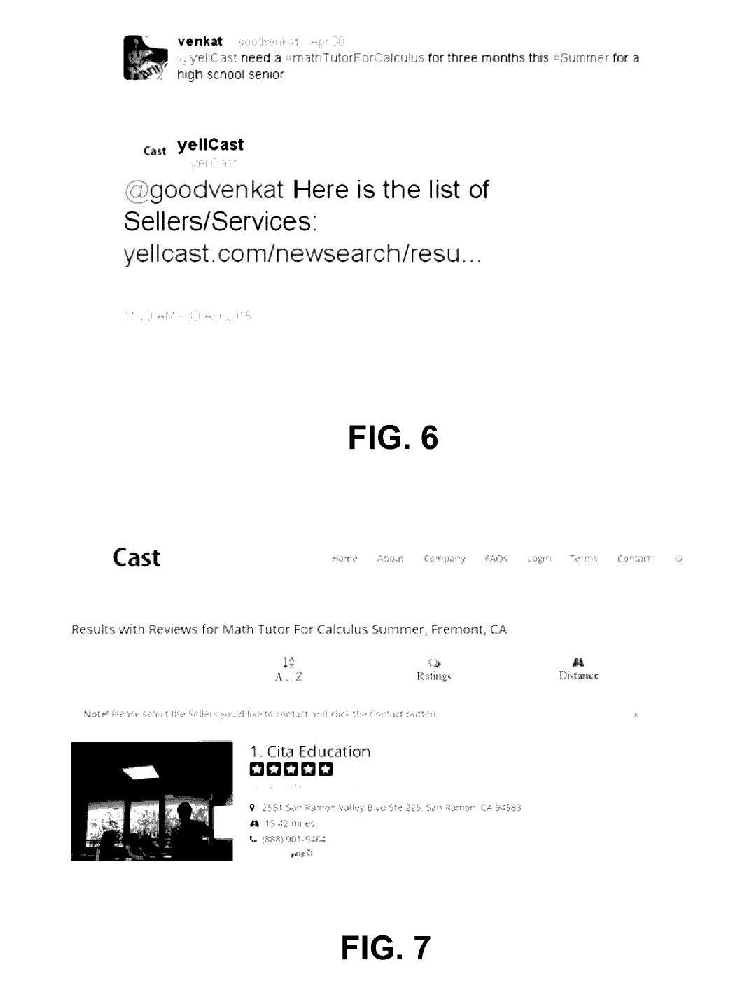

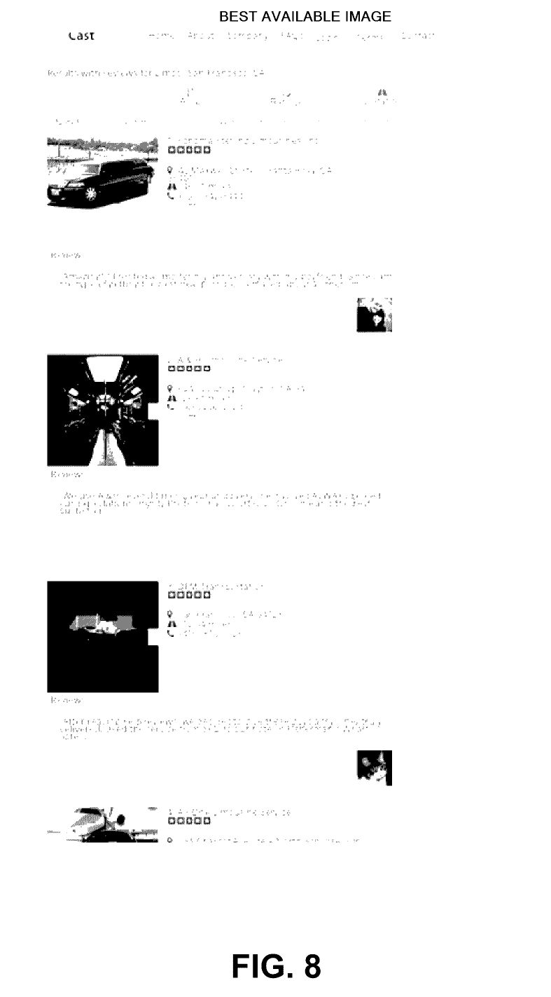

FIG. 6 illustrates that multi-word search phrases might be used in selection terms or identifiers, such as Twitter “hashtags” in messages. As illustrated in FIG. 7, the buyer can click on a link and be served a page from the web-based service that provides reviews for selected sellers for the services requested. This can be a co-branded or a fully integrated results page and provided with a list of sellers with photos and reviews obtained from local search listing providers such as Yelp, Yellow Pages, CityGrid, Google, etc. An example is shown in FIG. 8.

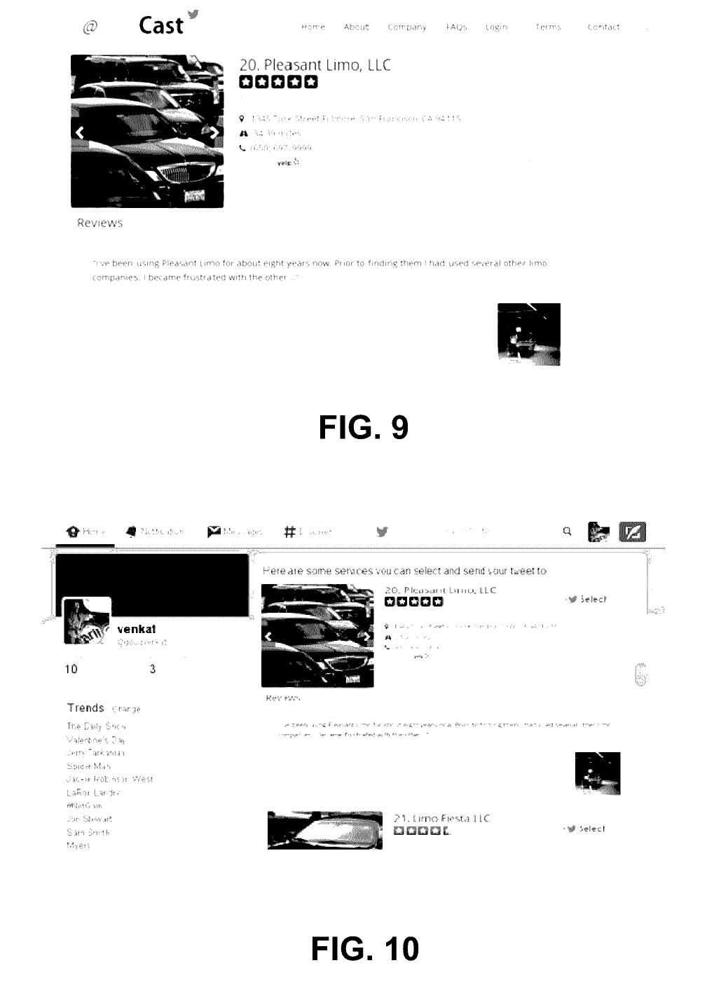

From there, the buyer reviews the list and selects any/all of the sellers they would like their request to be sent to and with a single click sends out the requests to multiple sellers, perhaps by selecting the “Contact the 7 selected” button shown in FIG. 9. FIG. 10 illustrates an integrated version of results listing page.

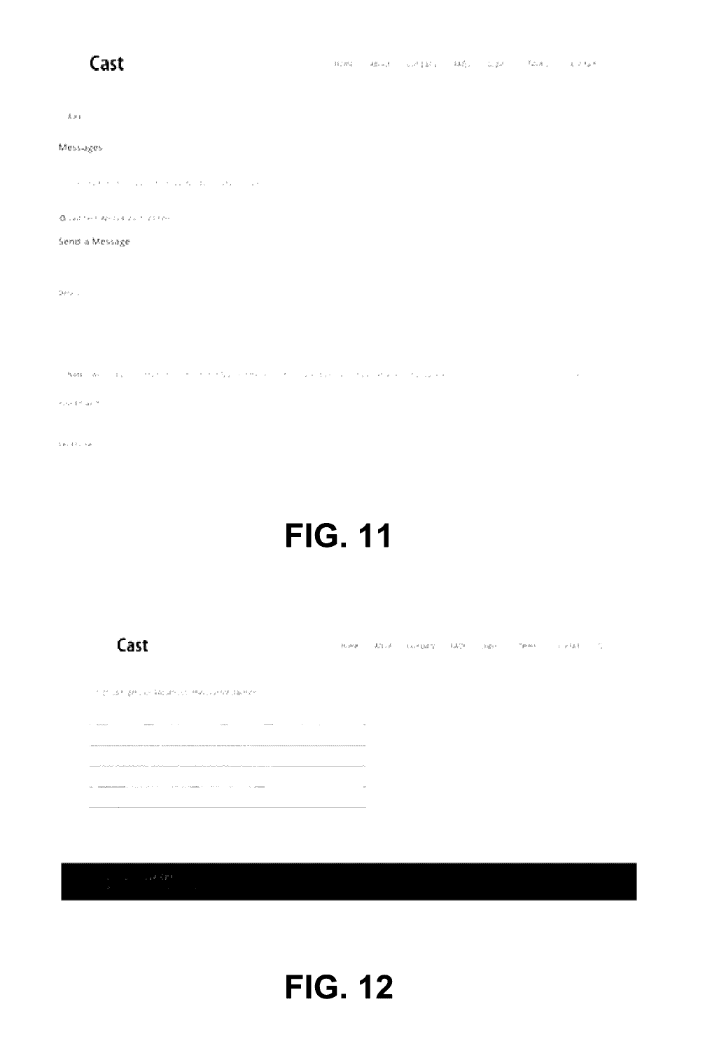

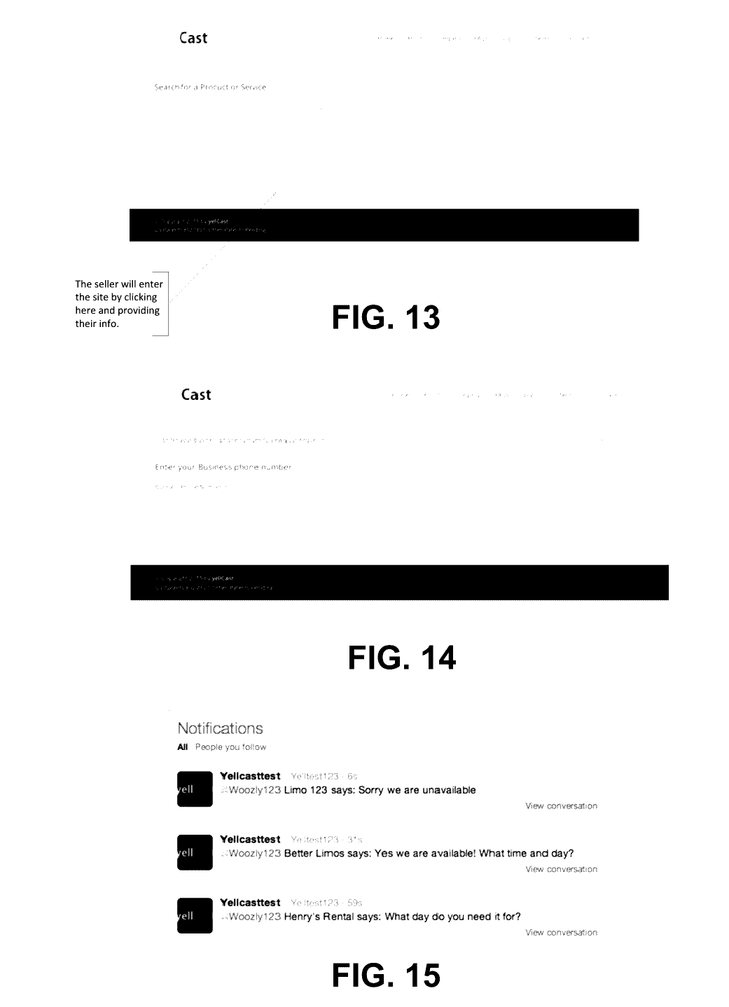

The selected sellers will initially receive notification of each request through an automated phone call/voice message that directs them to the yellCast website or the co-branded site. Using their phone number, they can find their free requests, choose and send messages directly to the buyer, and sign up to get future requests via text or email, as illustrated in FIGS. 11-14. The seller might receive as an example, five free requests, after which if the seller would like to respond to the next buyer's request, he/she will pay a small fee for every accepted request. Each buyer's request might generate fees. Alternately, the seller may agree to pay a percentage of the revenue earned through the request to yellCast. This integrates local search and messaging into a request-based revenue stream.

Next, the buyer receives response messages from each seller, as in FIG. 15.

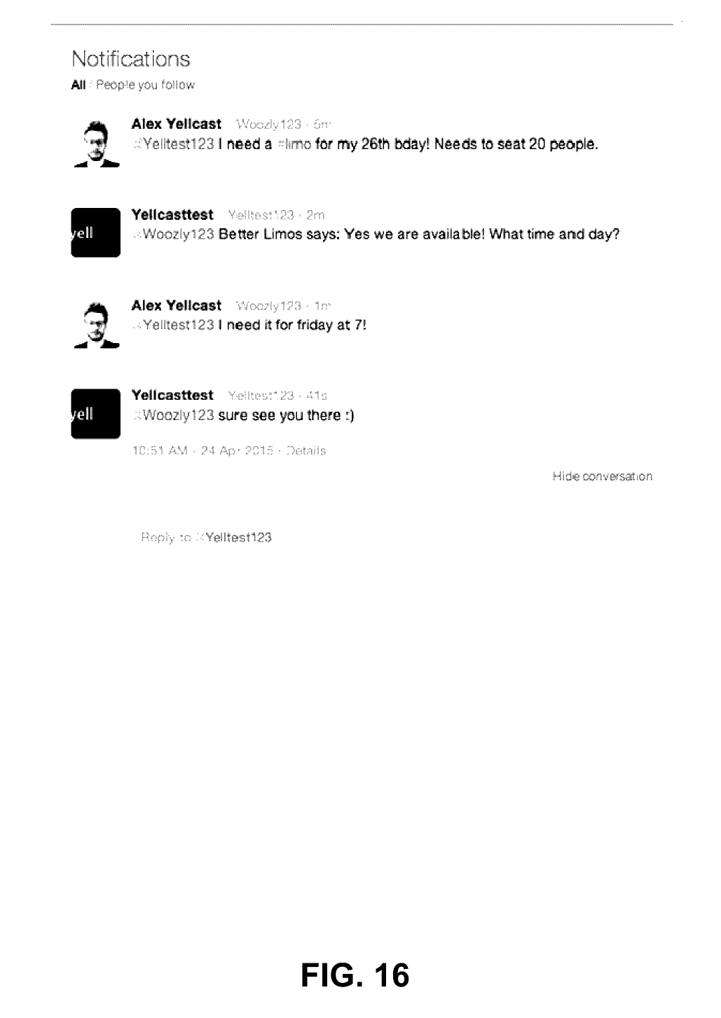

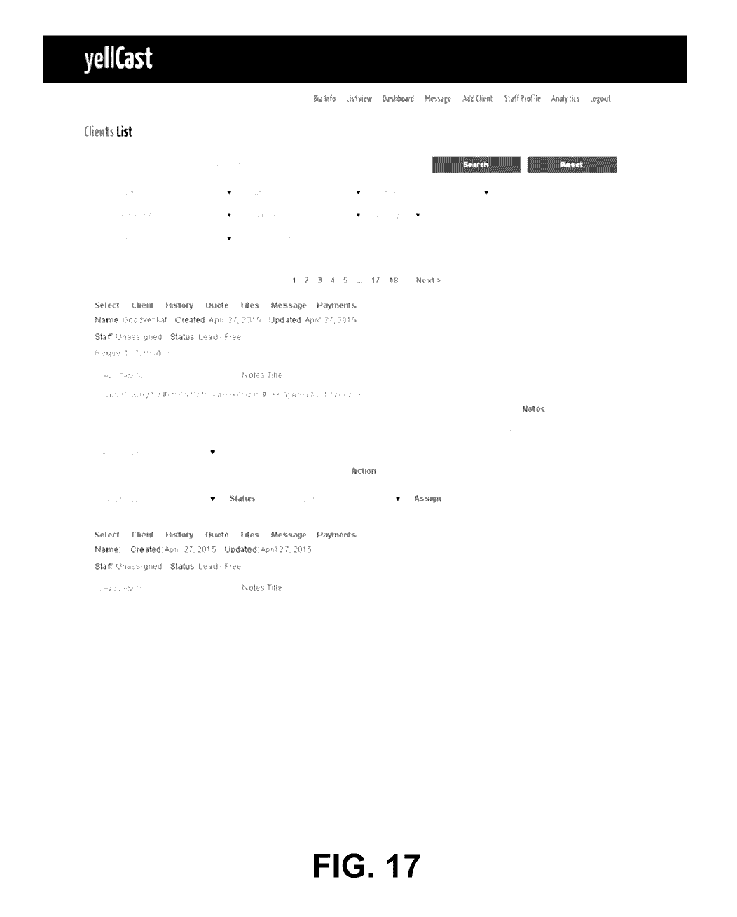

The buyer can continue the conversation with any/all of the sellers through tweet replies, adding photos and further details about what they are looking for until they reach their optimal choice of seller, as illustrated in FIG. 16. The sellers will continue to communicate from their end through the cobranded site. The seller can choose to manage buyer interaction using the built in CRM (Customer Relationship Management) system. FIG. 17 illustrates a seller CRM dashboard.

### Implementation in Program Code

The web-based service might be implemented using program code that interfaces to the Twitter Rest API V1.1 and server side code on yellCast environment with PHP, MySql and HTML5, Javascript.

Polling vs. Callback: A polling method is to be adopted once every minute to Get new mentions and replies from Twitter.

Alternately, yellCast could provide a secure URL for Twitter to call back when there is a new mention or reply to @yellCast. This will improve the response times and also avoid polling.

Multi word search phrase hashtags: For longer search keyword strings, we extend the hashtag format as #multiWordHashtag to denote multiple words in the hashtag. yellCast will combine multiple hashtags to coin the search phrase. In addition the location information is used as it is obtained from the user through the API.

### EXAMPLE

I am looking for a #highSchoolMathTutor this summer, well versed in #calculus.
yellCast could then combine the two hashtags and coin a keyword phrase as: “high school math tutor calculus”.
Mapping multiple reply threads for multiple sellers: The request and responses thread for each buyer to multiple sellers is maintained using IDs and storage in a database. As the buyer uses the reply-to functionality of Twitter, through the API the reply to message ID is obtained. This ID is saved with the request details sent to each seller in the database. The buyer is then posted with multiple seller responses as separate replies to the original tweet.
When the buyer responds with a reply to the corresponding seller response a respective message ID is obtained from Twitter. This message ID is matched with the seller information in the database and the message is forwarded to the respective seller through the system.
Private Tweets: @yellCast tweets (mentions and replies) are preferably private to that users can send requests that need to be private. Also the businesses would not like for other competing businesses to view their responses (price, service differentiation details that make them competitive).
Brand/Theme: The seller listing page will be a co-branded version. We will make changes to the look and feel to be a blend of the two companies.
Alternate Implementations: This outlined method uses the existing Twitter API and yellCast as a separate web service.

However, there may be other ways to implement such as the search results may not be sent as a link but displayed within the web pages of Twitter. This enables the buyer side to be completely Twitter domain based and the seller side to be yellCast domain based.

Another method may be as the sellers are reached over the phone and informed about the service, once they signup, a Twitter account may be created for them automatically. Then they may get all their requests on their Twitter account as Tweets with notifications and messages. In this method, the entire implementation logic including searches, display of listings, request and response communications, CRM, payments, etc. may then be integrated within the Twitter system.

In a particular embodiment, the Twitter API Calls used include “GET statuses/mentions timeline” (which returns the 20 most recent “mentions” for the authenticating user and the timeline returned is the equivalent of the one seen when the user vies their mentions at twitter.com); “POST statuses/update” (updates the authenticating user's current status, also known as tweeting; For each update attempt, the update text is compared with the authenticating user's recent tweets); and “POST media/upload” (upload images and other media to Twitter, to use in a Tweet or Twitter-hosted Card)

Other mobile application messaging platforms might be used, such as whatsapp, snapchat, skype, etc. Third-party software might be used to get and post messages for those other platforms. Using these software libraries to exchange messages, the yellCast buyer/seller communications can be performed.

The about outlined method of integrating messaging communications for buyers and sellers may be extended and implemented with these additional systems. A request with the search phrase included with delimiters such as hashtags and geo location can be obtained from the mobile device.

The request may be received by yellCast as another user and yellCast can save the request details including text, photos, video, or reference links to photos and videos, geo location and buyer profile information in its database with a reference code. Further the request can be matched with seller listings and a link created to view the matched results. Then post the results listing link to the buyer as a message. The buyer will click on the link, select the sellers to send the request to and click a button to send it to all of them selected.\

Any responses from the sellers will be posted back as a reply message to the buyer from the yellCast account. One of the differences being, the messages generated from the buyer to multiple sellers may be grouped into one and therefore needs a way to identify the buyer's message to be forwarded with the right seller it was intended to be sent to. There are ways of transmitting the business information such as name or an ID that corresponds to each response and forwarding the message to the appropriate seller.

Alternately, the intermediate logic could create multiple accounts for each seller and post a message as though it was sent from each of them.

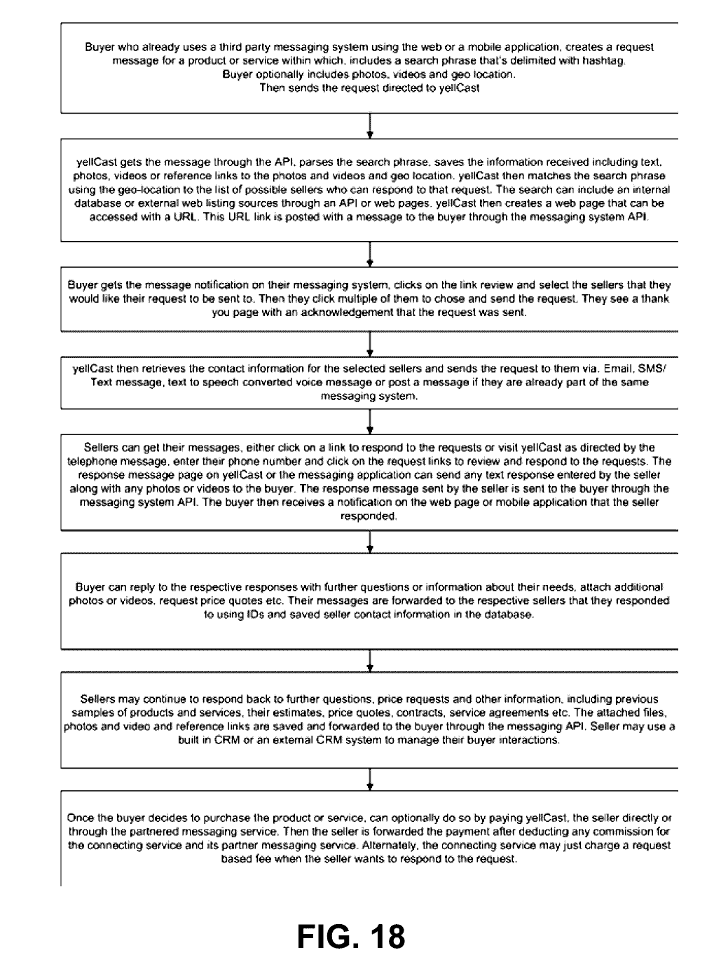

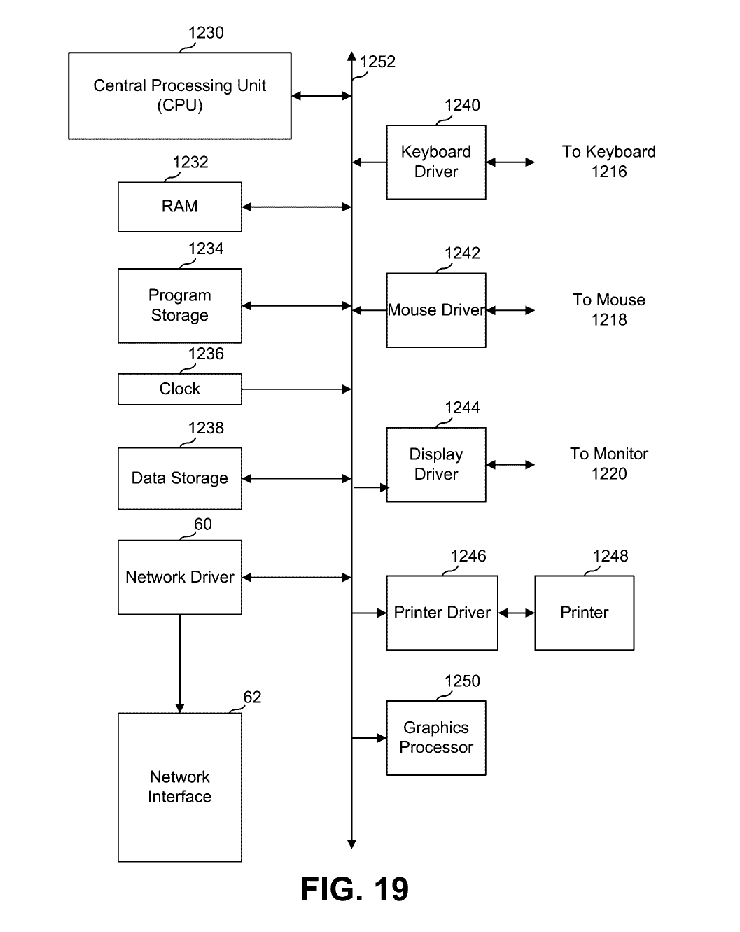

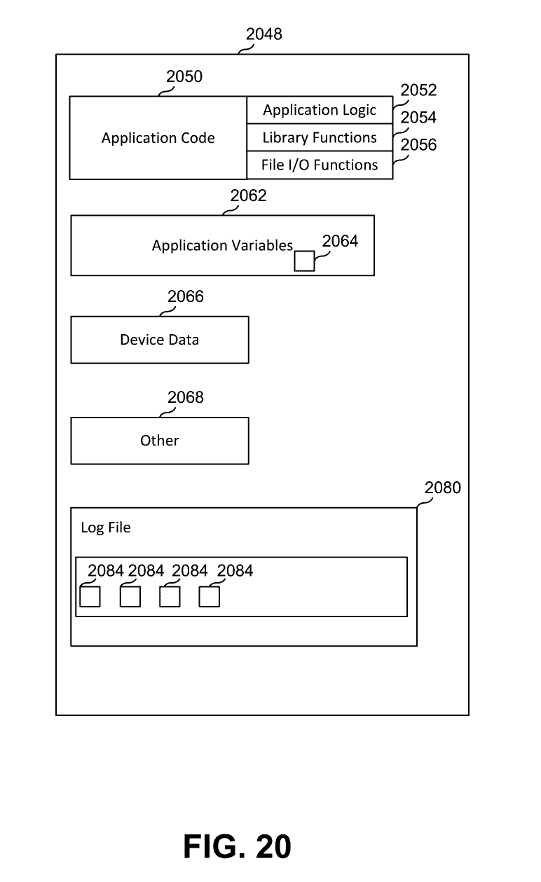

FIG. 18 illustrates a flow diagram of a process according to embodiments of the present invention. FIG. 19 illustrates possible computer components. FIG. 20 illustrates possible memory structures.

What is claimed is:

1. A computer-implemented method of facilitating an interactive request-based marketplace in which buyers communicate requests for products and/or services, and sellers respond to those requests.

2. The method of claim 1, wherein sellers or service providers may respond to buyer requests.
